(19) United States
(12) Patent Application Publication
(10) Pub. No.: US 2002/0009515 A1
(43) Pub. Date: Jan. 24, 2002

(54) MOLD BLOW MOLDED PRODUCT AND MOLDING METHOD

(76) Inventors: HIROSHI IWAMOTO, TOCHIGI (JP); YUKO TAMIYA, TOCHIGI (JP); MASAHARU HATA, TOCHIGI (JP); NAOHIDE NISHIMINE, TOCHIGI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/169,129

(22) Filed: Oct. 9, 1998

(30) Foreign Application Priority Data
Oct. 9, 1997 (JP) 9-277623

(51) Int. Cl. B29C 49/64

(52) U.S. Cl. 425/509; 425/522; 425/470

(57) ABSTRACT

In order to provide a mold of a shape which has been designed to take into account the deformation occurring during the cooling process, the mold cavity is formed so that the difference between the maximum and minimum shrinkage of the external size of the body portion of the molded product relative to the size of the mold cavity has a prescribed value.

### BACKGROUND OF THE INVENTION

1. Field of the Invention

The present invention claims priority from Japanese Patent Application No. 9-277623 filed Oct. 9, 1997, which is incorporated herein by reference. It relates to the molding of plastics, particularly to the shape of the mold used in molding techniques wherein the deformation occurring during cooling is predicted and the plastic molded product is removed from the mold at high temperature.

2. Description of Related Art

A widely practiced method of molding plastic is to extrude high-temperature molten plastic in a tubular shape, enclose this in a mold and cause it to expand by blowing air into the tube. A conventional example of this will be explained with reference to FIG. 3 to FIG. 6, which show the process of manufacturing a container by blow molding.

As shown in FIG. 3, molten plastic in tubular shape (the parison) is extruded into the middle of a split mold, and as shown in FIG. 4, the mold is then closed. As shown in FIG. 5, when air is blown into the molten plastic, the plastic adheres to the inner wall of the mold and assumes the same shape as this inner wall. At this point in time the molten plastic is at a high temperature of for example 200° C., and it is cooled and solidified by keeping it in the mold while continuing to blow in high-pressure air. The time required for this cooling varies according to the type of plastic and the form of the molded product, and cooling time has hitherto been determined on the basis of the criterion that deformation due to thermal shrinkage of the resin after removal from the mold is linear. As shown in FIG. 6, when the mold is opened, the molded product is removed.

The molded product shown in FIG. 6 is a container (a bottle) which will be marketed after being filled with a liquid, and the resin temperature at which a mold is opened is usually about 50° C. A dozen or so seconds are required for this cooling.

It thus takes time to cool the high-temperature molten plastic to a point at which the mold can be opened. Production per unit time and production cost are in inverse proportion, and in a manufacturing process in which time management is carried out in units of seconds, even a short cooling time of a dozen or so seconds should be shortened in order to achieve lower production cost.

In order to obtain data relating to the shortest practical cooling time, the inventors performed repeated experiments in which a molded product was released from a mold while still at a high temperature. These experiments showed that if a mold is opened up before the conventionally employed cooling time has elapsed, the high-temperature molten plastic shrinks greatly and undergoes nonlinear deformation, so that the target molded product shape is not obtained. In other words, it was found that cooling time could not be shortened.

It would therefore be desirable to predict the nonlinear deformation of a high-temperature molded product after it has been released from a mold, and to develop a mold which enables molten plastic to be molded in such a way that the shape after deformation is the desired shape.

### SUMMARY OF THE INVENTION

It is therefore an object of the present invention to provide a mold such that a target molded product shape can be obtained even though the cooling time in the plastic molding process is shortened.

Plastic which has been released from a mold undergoes shrinkage deformation in the course of cooling to ordinary temperature. Conventionally, removal of the plastic at a low temperature ensures a regularity in the resulting deformation, i.e. the deformation is linear, and therefore by taking the shrinkage factor into account when designing the mold size so as to make the mold suitably larger, the manufacturability of the target molded product shape (i.e. its design dimensions) can be guaranteed.

However, the broad regularity mentioned above is not found in the course of the nonlinear shrinkage which occurs when a plastic molded product is removed from a mold at high temperature. The inventors have therefore invented a method and apparatus for a mold design whereby a target molded product shape is obtained even when a molded product is removed from a mold at high temperature. This is achieved by using the finite element method to simulate deformation behavior, and by taking this deformation into account beforehand when fabricating the shape of the mold (Japanese Patent Application Laid-open No. 9-277260). This method and apparatus for mold design ensure that a mold shape which takes nonlinear deformation into account in advance is achieved.

According to a first aspect of the present invention, a mold for blow molding a thermoplastic product is formed so that the difference between the maximum and minimum shrinkage of the external size of the body portion of the molded product relative to the size of the mold cavity exceeds 0% and is at most 18.0%.

High-density polyethylene (HDPE) can be used for the aforementioned thermoplastic, and in this case the mold cavity is preferably formed so that the difference between the maximum and minimum shrinkage of the external size of the body portion of the molded product relative to the size of the mold cavity is at least 1.4% and at most 18.0%.

Polypropylene (PP) can also be used for the aforementioned thermoplastic, in which case the mold cavity is preferably formed so that the difference between the maximum and minimum shrinkage of the external size of the body portion of the molded product relative to the size of the mold cavity exceeds 0% and is at most 8.0%.

According to a second aspect of the present invention, a blow molded product and a molding method using the mold are provided.

According to a third aspect of the invention, a blow molded product on the body portion of which an in-mold label has been affixed during blow molding uses the aforementioned mold, said in-mold label excluding labels which do not thermally shrink after removal from a mold.

As has been explained above, the present invention is capable of providing a mold such that a target molded product shape can be obtained even though the cooling time in the plastic molding process is shortened.

### BRIEF DESCRIPTION OF THE DRAWINGS

FIG. 1 shows the front of a mold according to an embodiment of the present invention.

FIG. 2 shows the side of a mold according to an embodiment of the present invention.

FIG. 3 to FIG. 6 show the processes involved in manufacturing a container by blow molding.

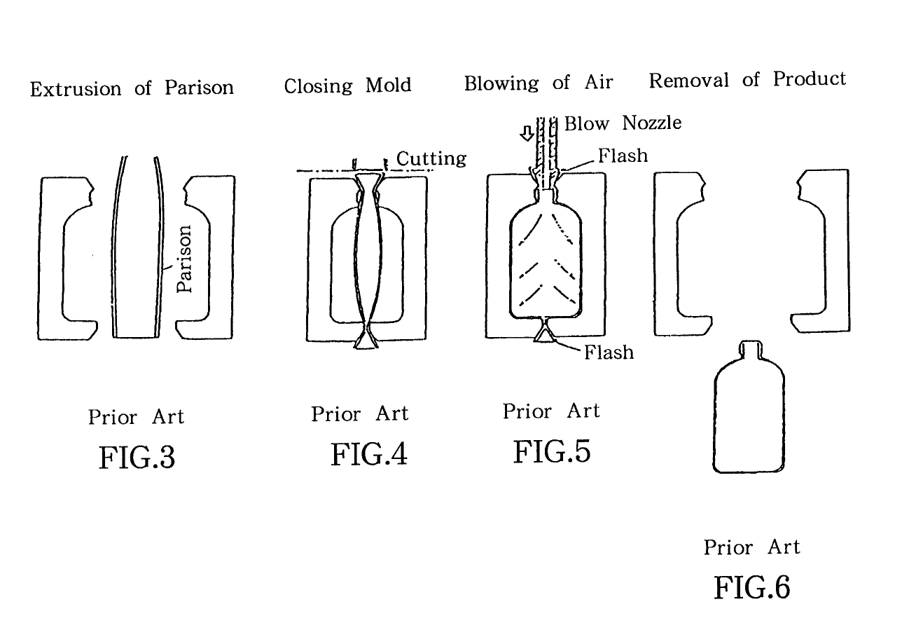

### DETAILED DESCRIPTION OF THE PREFERRED EMBODIMENTS

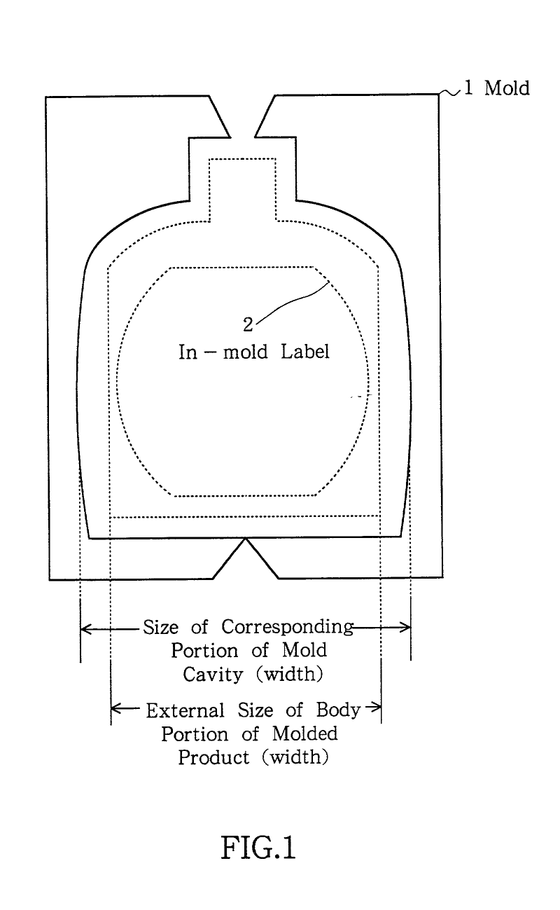

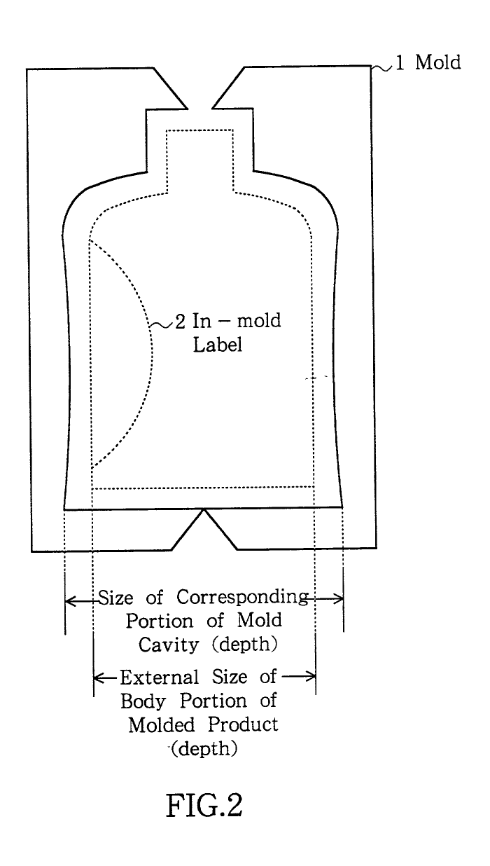

Embodiments of the invention will be explained with reference to FIG. 1 and FIG. 2, which respectively show the front and side of a mold according to embodiments of this invention. The broken lines in these figures indicate the shape of the molded product after cooling.

This invention is a mold 1 for blow molding a bottle, which is a blow molded product consisting of a thermoplastic, in which the mold cavity is formed so that the difference between the maximum and minimum shrinkage of the external size of the body portion of the molded product relative to the size of the cavity of mold 1 exceeds 0% and is at most 18.0%.

High-density polyethylene (HDPE) can be used for the aforementioned thermoplastic, and in this case the mold cavity is formed so that the difference between the maximum and minimum shrinkage of the external size of the body portion of the molded product relative to the size of the cavity of mold 1 is at least 1.4% and at most 18.0%.

Polypropylene (PP) can also be used for the aforementioned thermoplastic, in which case the mold cavity is formed so that the difference between the maximum and minimum shrinkage of the external size of the body portion of the molded product relative to the size of the cavity of mold 1 exceeds 0% and is at most 8.0%.

In-mold label 2 is affixed to the molded product during blow molding, said in-mold label excluding labels which do not thermally shrink after removal from a mold.

These embodiments of the invention will now be further explained with reference to the following table.

### Table

TABLE

| Type of plastic | | HDPE | | | PP | |
|---|---|---|---|---|---|---|
| embodiments | | A | B | C | D | E |
| difference between max. and | width | 1.4 | 2.7 | 4.0 | 0.0 | 0.4 |
| min. shrinkage of external | depth | 5.8 | 2.9 | 17.5 | 3.3 | 7.6 |
| size of body | | | | | | |
| portion of molded product | | | | | | |
| relative to size of mold | | | | | | |
| cavity (%) | | | | | | |
| cooling time (seconds) | | 5.5 | 5.0 | 7.0 | 7.0 | 4.5 |
| removal temperature (° C.) | | 94 | 104 | 80 | 85 | 82 |

High-density polyethylene (HDPE) and polypropylene (PP) are used in these embodiments as the material for the bottle. When HDPE is used, the temperature of the body portion of the molded product when it is removed from mold 1 according to these embodiments is 80° C. to 104° C. This removal temperature was measured at the body portion of the molded product immediately after it was removed from mold 1, using a radiation thermometer (a TVS-100 manufactured by Nippon Avionics Co., Ltd.). The body portion here means the portion of the container from the bottom face to the neck. Hence the molded product can be removed from the mold at a considerably higher temperature than the conventional removal temperature of 45 ° C. to 57° C.

When HDPE is used, mold 1 from which a molded product can be removed at high temperature has a mold cavity formed so that the difference between the maximum and minimum shrinkage of the external size of the body portion of the molded product relative to the size of the cavity of mold 1 is at least 1.4% and at most 18.0%.

The preferred embodiments in the case of HDPE are high-speed products A and C. For these, the difference between the maximum and minimum shrinkage of the external size of the body portion of the molded product relative to the size of the mold cavity is respectively 1.4% and 17.5%. Preferably, the difference between the maximum and minimum shrinkage of the external size of the body portion of the molded product relative to the size of the cavity of mold 1 is at least 1.4% and at most 17.5%.

In an embodiment in which the molded product has a waist, the difference between the maximum and minimum shrinkage of the body portion of the molded product is at least 10.0% and at most 17.5%.

In the prior art the difference between the maximum and minimum shrinkage of the external size of the body portion of the molded product relative to the size of the mold cavity was approximately 0%.

When PP is used, the temperature of the body portion of the molded product when it is removed from a mold according to these embodiments is 82° C. to 85° C. This removal temperature was measured in the same way as in the case of the HDPE molded products. The molded PP product can be removed from the mold at a considerably higher temperature than the conventional mold removal temperature of 46° C. to 62° C.

When PP is used, mold 1 from which a molded product can be removed at high temperature has a mold cavity formed so that the difference between the maximum and minimum shrinkage of the external size of the body portion of the molded product relative to the size of the cavity of mold 1 exceeds 0% and is at most 8.0%.

The preferred embodiment in the case of PP is high-speed molded product D. For this, the difference between the maximum and minimum shrinkage of the external size of the body portion of the molded product relative to the size of the cavity of mold 1 is approximately 3.3%. Preferably, the difference between the maximum and minimum shrinkage of the external size of the body portion of the molded product relative to the size of the cavity of mold 1 is at least 3.3% and at most 5.9%.

In the prior art the difference between the maximum and minimum shrinkage of the external size of the body portion of the molded product relative to the size of the mold cavity exceeded 0% and was at most 1.1%. As shown in the table, the cooling time can be reduced from the 7 to 12 seconds required with a prior art mold to 4.5 to 7.0 seconds.

What is claimed is:

1. A mold for blow molding a thermoplastic product, comprising a mold cavity sized and shaped such that a difference between a maximum and a minimum shrinkage of the external size of a body portion of the molded product, relative to the size of the mold cavity, is greater than 0% and is at most 18.0%.

2. A mold according to claim 1, wherein the thermoplastic is high-density polyethylene (HDPE), and the mold cavity is sized and shaped so that the difference between the maximum and minimum shrinkage of the external size of the body portion of the molded product, relative to the size of the mold cavity, is between 1.4% and 18.0%.

3. A mold according to claim 1, wherein the thermoplastic is polypropylene (PP), and the mold cavity is sized and shaped so that the difference between the maximum and minimum shrinkage of the external size of the body portion of the molded product, relative to the size of the mold cavity, is greater than 0% and is at most 8.0%.

4. A blow molding method comprising the steps of:
providing a mold comprising a mold cavity sized and shaped such that a difference between a maximum and a minimum shrinkage of the external size of a body portion of the molded product, relative to the size of the mold cavity, is greater than 0% and is at most 18.0%;
molding the product in the mold cavity; and
permitting the molded product to shrink.

5. A blow molded product on the body portion of which an in-mold label has been affixed during blow molding using a mold comprising a mold cavity sized and shaped such that a difference between a maximum and a minimum shrinkage of the external size of a body portion of the molded product, relative to the size of the mold cavity, is greater than 0% and is at most 18.0%, said in-mold label excluding labels which do not thermally shrink after removal from the mold.
